(19) United States
(12) Patent Application Publication
(10) Pub. No.: US 2015/0202952 A1
(43) Pub. Date: Jul. 23, 2015

(54) VEHICLE COVER SYSTEM

(71) Applicant: Mokhtar Karboul, Montreal (CA)

(72) Inventor: Mokhtar Karboul, Montreal (CA)

(21) Appl. No.: 14/598,993

(22) Filed: Jan. 16, 2015

(30) Foreign Application Priority Data
Jan. 22, 2014 (CA) 2840660
Jul. 22, 2014 (CA) 2857706
Aug. 14, 2014 (CA) 2859535

(51) Int. Cl. B60J 11/00

(52) U.S. Cl. CPC B60J 11/00

(57) ABSTRACT

A vehicle cover system for covering a vehicle, the vehicle cover system comprising: at least one support element mountable to the vehicle, the at least one support element including a support vehicle mounting portion mountable to the vehicle, a support cover receiving portion spaced apart from the support vehicle mounting portion and a support spacing portion extending therebetween; and a cover element, the cover element defining at least one cover mounting portion, the cover mounting portion being mounted to the support cover receiving portion. When mounted to the vehicle in an operative configuration, the at least one support element supports the cover element over the vehicle in a substantially convex configuration with at least part thereof spaced apart from the vehicle.

### FIELD OF THE INVENTION

The present invention relates generally to the protection of vehicles against the elements, and, more particularly, to a vehicle cover system for covering the vehicle.

### BACKGROUND

There are many existing vehicle cover systems used to protect vehicles such as cars, against the elements, such as snow, rain and extreme temperatures. However, most of these systems are either relatively large and expensive when they take the form of shelters, or they consist simply in a tarp that is used to cover the vehicle. In the latter case, the tarp conforms to the shape of the vehicle, which may trap moisture between the tarp and the vehicle, thereby promoting corrosion. Also, when snow falls, the snow accumulates on the tarp as it would on the vehicle, and to use the vehicle one must either clean the snow in a conventional manner, or remove the tarp with the snow thereon, which may be difficult for large vehicles, or when there is a lot of snow on the tarp. Furthermore, tarps typically allow snow to accumulate under the vehicle. When shelters are used, they are typically used only at locations where the vehicle is parked often, such as at the home of the owner and are not easily carried to protect the vehicle at other locations. Also, shelters are time consuming and relatively hard to install.

Against this background, there exists a need for an improved vehicle cover system.

An object of the present invention is to provide such a vehicle cover system.

### SUMMARY OF THE INVENTION

In a broad aspect, the invention provides a vehicle cover system for covering a vehicle, the vehicle cover system comprising: at least one support element mountable to the vehicle, the at least one support element including a support vehicle mounting portion mountable to the vehicle, a support cover receiving portion spaced apart from the support vehicle mounting portion and a support spacing portion extending therebetween; and a cover element, the cover element defining at least one cover mounting portion, the cover mounting portion being mounted to the support cover receiving portion. When mounted to the vehicle in an operative configuration, the at least one support element supports the cover element over the vehicle in a substantially convex configuration with at least part thereof spaced apart from the vehicle.

In some embodiments, the at least one cover mounting portion includes a plurality of cover mounting portions; and the at least one support element includes a plurality of support elements mountable to the vehicle, the support elements including each a support vehicle mounting portion mountable to the vehicle, a support cover receiving portion spaced apart from the support vehicle mounting portion for receiving a respective one of the cover mounting portions and a support spacing portion extending therebetween.

In some embodiments, when mounted to the vehicle in an operative configuration, the support elements support the cover element over the vehicle in a substantially spaced apart relationship relative thereto.

In some embodiments, at least part of the at least one support element is removable mountable to the vehicle.

In some embodiments, the support vehicle mounting portion is removable mountable to the vehicle.

In some embodiments, the support vehicle mounting portion includes a suction element for creating a suction to secure the support vehicle mounting portion to the vehicle.

In some embodiments, the support vehicle mounting portion includes a magnet for magnetically securing the support element to the vehicle.

In some embodiments, the support spacing portion is removable mountable to the support vehicle mounting portion, for example through a dovetail joint.

In some embodiments, the cover mounting portion is removably mountable to the support cover receiving portion. For example, the cover mounting portion defines an aperture extending through the cover element; the support cover receiving portion defines a platform for abutting the cover mounting portion thereagainst and a protrusion configured and sized for extending through the aperture and protruding therethrough when the cover mounting portion is operatively mounted to the support cover receiving portion with the cover mounting portion abutting against the platform, the platform being larger than the aperture so as to be unable to pass therethrough.

In some embodiments, the protrusion defines a protrusion spacing segment extending from the platform and a hook extending from the protrusion spacing segment opposed to said platform, at least part of the hook extending at an angle relative to the protrusion spacing segment.

In some embodiments, the protrusion spacing segment is substantially perpendicular to the platform.

In some embodiments, the protrusion is provided with a lock operable between a locked configuration and an unlocked configuration, wherein in the unlocked configuration, the aperture is freely movable along the protrusion; and in the locked configuration, the aperture is restrained on the protrusion so that the cover mounting portion is unable to move out of the protrusion.

In some embodiments, the cover element includes a substantially flexible cover sheet. For example, the cover sheet is a tarp. In a specific example, the tarp is impermeable.

In some embodiments, the cover sheet is substantially rectangular when flattened.

In some embodiments, the at least one support element includes three support elements mounted respectively to a roof, a front portion and a rear portion of the vehicle when the vehicle cover system is operatively mounted to the vehicle.

In some embodiments, the at least one support element includes five support elements mounted respectively to a roof and at a respective one of four corners of the vehicle when the vehicle cover system is operatively mounted to the vehicle.

In some embodiments, the support spacing portion of the at least one support element is substantially rectilinear and extends away from the support vehicle mounting portion.

In some embodiments, the support spacing portion of the at least one support element is substantially L-shaped.

In some embodiments, the support vehicle mounting portion defines a mounting surface facing the vehicle when the support vehicle mounting portion is operatively mounted to the vehicle and an opposed free surface; the support spacing portion of the at least one support element extending from the free surface, defining a zenith and curving away from the zenith so that a mounting plane containing the mounting surface intersects the support spacing portion at a location intermediate the zenith and the support cover receiving portion.

In some embodiments, the cover element has a substantially rectangular circus tent shape so as to cover a substantially rectangular area when mounted in an operational configuration to the vehicle, the cover element defining a substantially parallelepiped shaped bottom portion and a substantially pyramidal shaped top portion extending therefrom.

In some embodiments, the vehicle includes at least one wheel and is provided above a ground surface, the at least one support element being a vehicle mountable support element. The vehicle cover system further comprises at least one ground mountable support element, the ground mountable support element including a ground supported portion positionable on the ground, a ground support cover receiving portion spaced apart from the ground supported portion and a ground support spacing portion extending therebetween wherein, when the at least one ground mountable support element is mounted in an operative configuration, the ground supported portion is inserted between the at least one wheel and the ground and the vehicle cover is secured to the ground support cover receiving portion. For example, the ground supported portion is substantially plate-shaped.

Advantageously, the proposed vehicle cover system may present relatively steep surfaces so as to minimize snow accumulation thereonto when mounted to the vehicle. Also, the vehicle cover system includes a cover element that, in some embodiments, may be entirely, or almost entirely spaced apart from the vehicle, which minimizes corrosion and possible damages to the paint of the vehicle.

The proposed vehicle cover system is also relatively easy to use and manufacturable at relatively low costs in some embodiments.

Other objects, advantages and features of the present invention will become more apparent upon reading of the following non-restrictive description of some embodiments thereof, given by way of example only with reference to the accompanying drawings.

### BRIEF DESCRIPTION OF THE DRAWINGS

FIG. 1, in a side elevation view, illustrates a vehicle cover system in accordance with an embodiment of the present invention, the vehicle cover system being shown mounted to the vehicle;

FIG. 2, in top plan view, illustrates the vehicle cover system shown in FIG. 1;

FIG. 3, in top plan view, illustrates a cover element part of the vehicle cover system shown in FIGS. 1 and 2;

FIG. 4, in a side elevation view, illustrates a support element of a first type part of the vehicle cover system shown in FIGS. 1 and 2;

FIG. 4A, in a side elevation view, illustrates an alternative support element usable in the vehicle cover system shown in FIGS. 1 and 2;

FIG. 4B, in a side cross-sectional view, illustrates an alternative support vehicle mounting portion usable in the support element shown in FIG. 4;

FIG. 5, in a top plan view, illustrates the support element shown in FIG. 4;

FIG. 6, in a side elevation view, illustrates a support element of a second type part of the vehicle cover system shown in FIGS. 1 and 2;

FIG. 7, in a top plan, illustrates the support element shown in FIG. 6;

FIG. 8, in a side elevation view, illustrates another alternative support element of a first type usable in the vehicle cover system shown in FIGS. 1 and 2, the support element being here shown with a support spacing portion thereof unmounted from a support vehicle mounting portion thereof;

FIG. 9, in a front elevation view, illustrates the support element shown in FIG. 8, the support element being here shown with the support spacing portion unmounted from the support vehicle mounting portion;

FIG. 10, in a top plan view, illustrates the support element shown in FIGS. 8 and 9, the support element being here shown with the support spacing portion unmounted from the support vehicle mounting portion;

FIG. 11, in a side elevation view, illustrates the support element shown in FIGS. 8 to 10, the support element being here shown with the support spacing portion mounted to the support vehicle mounting portion;

FIG. 12, in a front elevation view, illustrates the support element shown in FIGS. 8 to 11, the support element being here shown with the support spacing portion mounted to the support vehicle mounting portion;

FIG. 13, in a top plan view, illustrates the support element shown in FIGS. 8 to 12, the support element being here shown with the support spacing portion mounted to the support vehicle mounting portion;

FIG. 14, in a side elevation view, illustrates another alternative support element of a second type usable in the vehicle cover system shown in FIGS. 1 and 2, the support element being here shown with a support spacing portion thereof unmounted from a support vehicle mounting portion thereof;

FIG. 15, in a front elevation view, illustrates the support element shown in FIG. 14;

FIG. 16, in a top plan view, illustrates the support element shown in FIGS. 14 and 15;

FIG. 17, in a side elevation view, illustrates a vehicle cover system in accordance with another embodiment of the present invention, the vehicle cover system being shown mounted to the vehicle;

FIG. 18, in a side elevation view, illustrates yet another alternative support element of a second type used in the vehicle cover system shown in FIG. 17, the support element being here shown with a support spacing portion thereof mounted from a support vehicle mounting portion thereof and with a lock thereof in a locked configuration;

FIG. 19, in a front elevation view, illustrates the support element shown in FIG. 18, the support element being here shown with the lock thereof in the locked configuration;

FIG. 20, in a top plan view, illustrates the support element shown in FIGS. 18 and 19, the support element being here shown with the lock thereof in the locked configuration; and

FIG. 21, in a top plan view, illustrates the support element shown in FIGS. 18 to 20, the support element being here shown with the lock thereof in an unlocked configuration;

FIG. 22, in a top plan view, illustrates the vehicle cover system shown in FIG. 17;

FIG. 23, in a side elevation view, illustrates a vehicle cover system in accordance with yet another embodiment of the present invention, the vehicle cover system being shown mounted to the vehicle;

FIG. 24, in a top plan view, illustrates the vehicle cover system shown in FIG. 23;

FIG. 25, in a top plan exploded view, illustrates a ground mountable support element part of the vehicle cover system shown in FIGS. 23 and 24; and

FIG. 26, in a side elevation exploded view, illustrates the ground mountable support element shown in FIG. 25.

### DETAILED DESCRIPTION

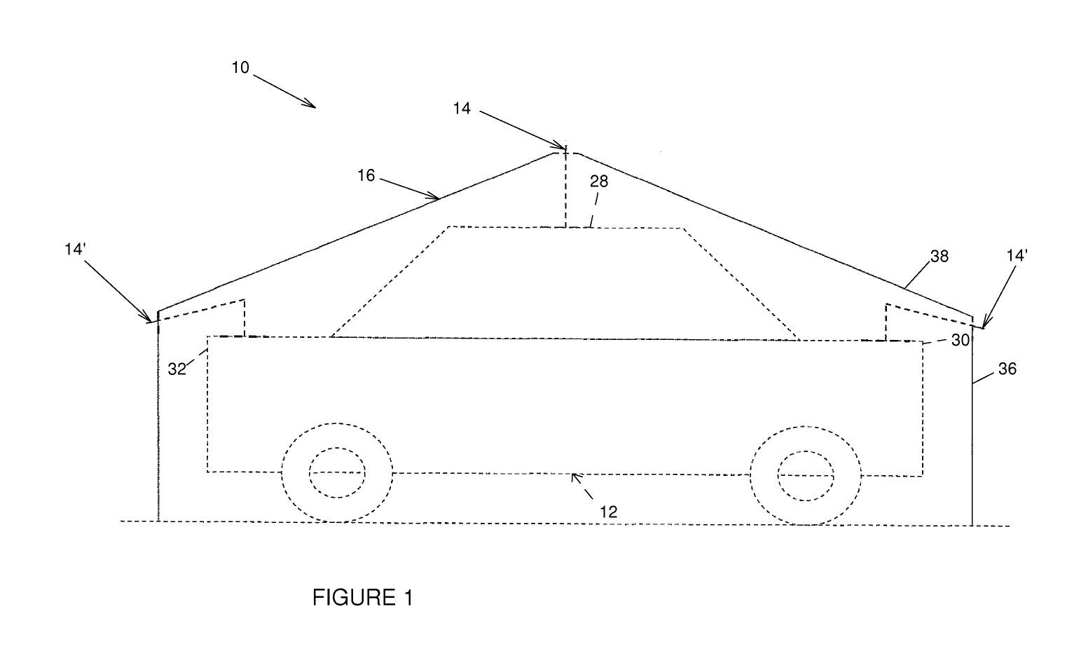

FIGS. 1 to 7 illustrates various aspects of an embodiment of a vehicle cover system 10 for covering a vehicle 12 (seen in FIGS. 1 an 2) in accordance with an embodiment of the present invention. Referring for example to FIG. 1, the vehicle cover system 10 comprises at least one support element 14 mountable to the vehicle 12 and a cover element 16 mounted to the at least one support element 14. The vehicle 12 may be a car, as shown in the drawings, a truck, sport utility vehicle (SUV) a mini-van, a motorcycle, a boat, an airplane or any other suitable vehicle.

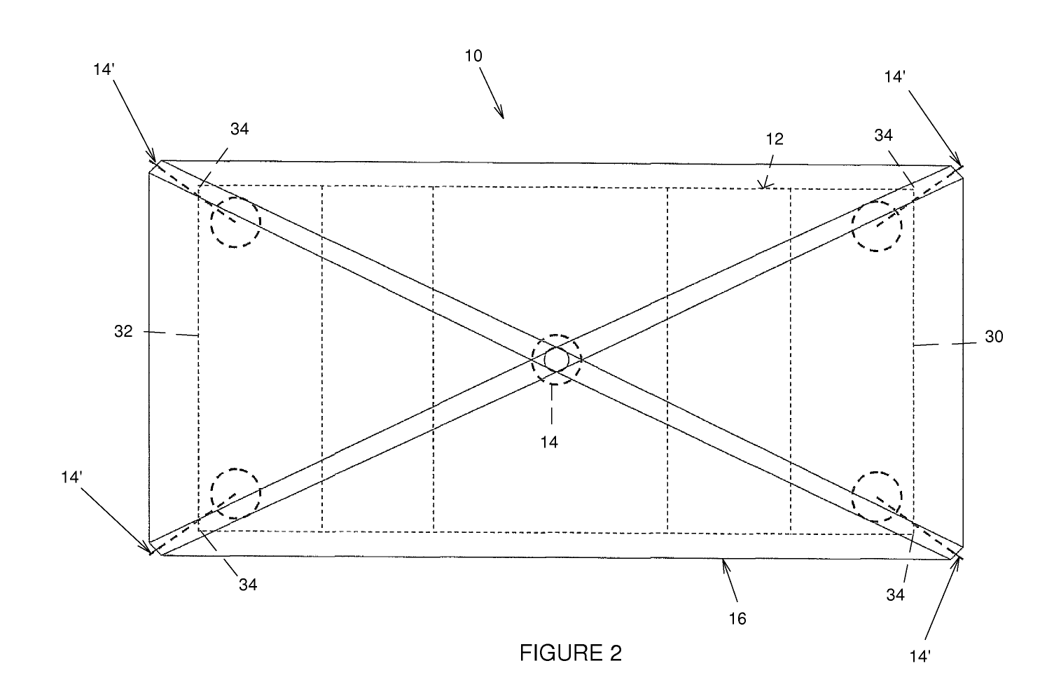

Typically, the vehicle cover system 10 includes more than one support elements 14. For example, in some embodiments, the vehicle cover system 10 includes at least three support elements 14, 14′ mountable respectively to a roof 28, a front portion 30 and a rear portion 32 of the vehicle 12 when the vehicle cover system 10 is operatively mounted to the vehicle 12. In some embodiments, as better seen in FIG. 2, the vehicle cover system 10 includes five support elements 14, 14′ mountable respectively to the roof 28 and at a respective one of four corners 34 of the vehicle 12 when the vehicle cover system 10 is operatively mounted to the vehicle 12. Other numbers of support elements 14, 14′ are also within the scope of the invention.

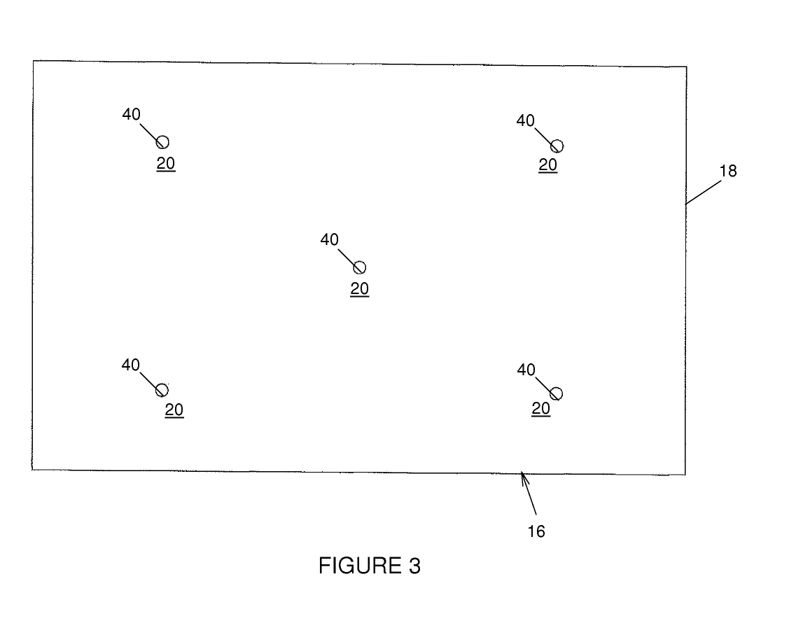

FIG. 3 illustrates an embodiment of the cover element 16 shown removed from the support elements 14, 14′ and in a flattened configuration. In this embodiment, the cover element 16 includes a substantially flexible cover sheet, for example in the form of a tarp and defines a cover element peripheral edge 18. Typically, the cover element 16 consists in an impermeable tarp, but other cover elements 16 are also within the scope of the invention. Also, the cover element 16 shown in the drawings is substantially rectangular when flattened. When mounted to the vehicle 12, the cover element 16 has a substantially circus tent rectangular shape so as to cover a substantially rectangular area when mounted upstanding, and defining a substantially parallelepiped shaped bottom portion 36 and a substantially pyramidal shaped top portion 38, as seen in FIG. 1. It should be noted that this general configuration can also be obtained from a rectangular tarp that will then have fold therein or from a tarp or other cover element 16 having intrinsically this shape so that no folds are created when mounting the cover element 16 to the support elements 14, 14′. Finally, in alternative embodiments of the invention, the cover element 16 is rigid or semi-rigid.

Referring to FIG. 3, the cover element 16 defines at least one cover mounting portion 20. The number of cover mounting portions 20 is typically the same as the number of support elements 14, 14′. The cover mounting portions 20 are each mounted to a respective one of the support elements 14, 14′, as detailed hereinbelow. In some embodiments of the invention, each cover mounting portion 20 defines an aperture 40 extending through the cover element 16. Although not shown in the drawings, each aperture 40 may be reinforced at the periphery thereof by additional layers of tarp material, or polymer or metallic rings centered thereonto and secured to the cover mounting portions 20. In the specific embodiment of the invention shown in the drawings, one of the apertures 40 is provided substantially centrally in the cover element 16 and four other apertures 40 are arranged in a rectangular configuration spaced apart from the cover element peripheral edge 18.

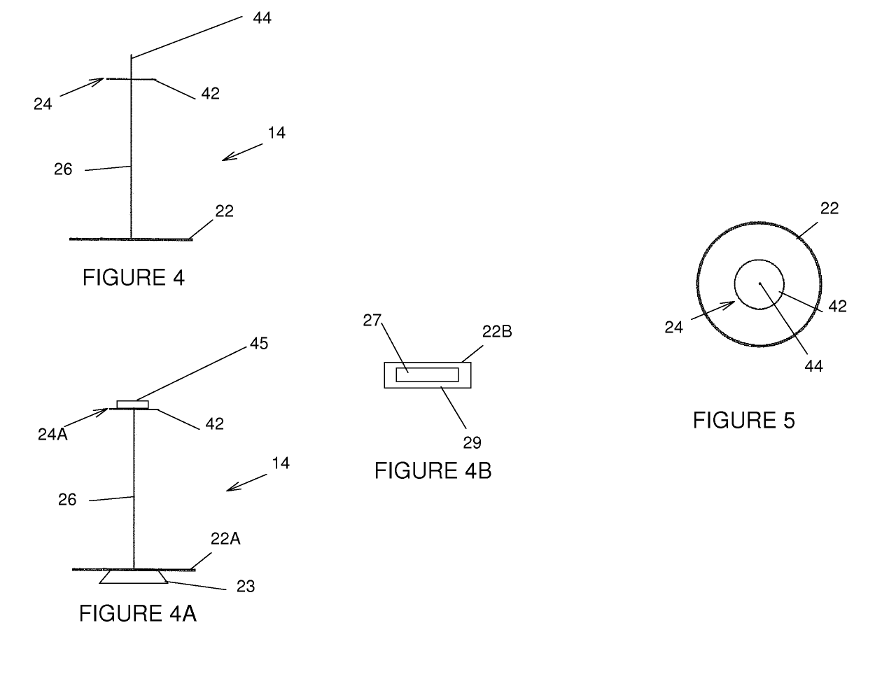

FIG. 4 illustrates one of the support elements 14. In a specific embodiment of the invention, the support element 14 is mountable to the roof 28. The support element 14 includes a support vehicle mounting portion 22 mountable to the vehicle 12, a support cover receiving portion 24 spaced apart from the support vehicle mounting portion 22 and a support spacing portion 26 extending therebetween. In an operational configuration, one of the cover mounting portions 20 is mounted to the support cover receiving portion 24. Typically, the cover mounting portion 20 is removably mountable to the support cover receiving portion 24, but embodiments in which the cover mounting portion 20 is permanently mounted to the support cover receiving portion 24 are within the scope of the present invention.

When mounted to the vehicle 12 in an operative configuration, the support element 14 supports the cover element 16 over the vehicle 12 in a substantially convex configuration with at least part thereof spaced apart from the vehicle 12. For the purpose of this document, the terminology “substantially convex” refers to an object that, when viewed from the outside, does not show any concave portion along most of its surface. Flat portions of the outer surface are allowed to remain within the scope of this definition, as are incidental small and/or shallow concave portions that cover only a very small portion of the cover element 16, for example 0.5% of the total surface thereof. The concave portions may be for example folds in the tarp, more particularly at the corners 34 of the vehicle 12. Advantageously, the convex configuration helps in preventing significant snow accumulations on the cover element 16, and if some snow somehow becomes stuck to the cover element 16, removing this snow is relatively rapid and easy to do.

The support vehicle mounting portion 22 is mountable to the vehicle 12 in any suitable manner. Typically, the support vehicle mounting portion 22 is removably mountable to the vehicle 12. For example, the support vehicle mounting portion 22 consists in a magnet for magnetically securing the support element 14 to the vehicle 12. In another example, as seen in FIG. 4B, the support vehicle mounting portion 22 consists in a disc-shaped magnet 27 covered with a suitable layer of material 29, such a rubber or fabric, so as to not scratch the paint of the vehicle 12. In another embodiment, as seen in FIG. 4A, the support vehicle mounting portion 22A includes a suction element 23 for creating a suction to secure the support vehicle mounting portion 22A to the vehicle 12. In alternative embodiments of the invention, not shown in the drawings, the support vehicle mounting portion 22 is permanently mountable to the vehicle 12, for example using an adhesive, screws, or nuts and bolts, among other possibilities.

The support spacing portion 26 extends from the support vehicle mounting portion 22. For example, the support spacing portion 26 extends integrally from the support vehicle mounting portion 22 and is permanently fixed thereto. In the specific embodiment shown in FIG. 4, the support spacing portion 26 of the support element 14 is substantially rectilinear and extends away from the support vehicle mounting portion 22 perpendicularly thereto. The support spacing portion 26 is typically rigid enough so as to keep its shape when the vehicle cover system 10 is mounted to the vehicle 12 and may have any suitable transversal cross-sectional configuration, such as a circular, rectangular, square or other configuration and be either tubular in nature or completely solid.

The support cover receiving portion 24 extends from the support spacing portion 26, typically integrally and fixedly therefrom and defines a platform 42 for abutting the cover mounting portion 20 thereagainst and a protrusion 44 configured and sized for extending through the aperture 40 and protruding therethrough when the cover mounting portion 20 is operatively mounted to the support cover receiving portion 24 with the cover mounting portion 20 abutting against the platform 42. The platform 42 is larger than the aperture 40 so as to be unable to pass therethrough.

The platform 42 is provided between the support spacing portion 26 and the protrusion 44 and can have any suitable shape. For example, the platform 42 is disc-shaped, as seen in FIG. 5. In some embodiments, as shown in FIG. 4, the protrusion 44 is rectilinear and coaxial with the support spacing portion 26.

The support element 14 is made of any suitable material, and may include metals, polymers, or combinations thereof, among other possibilities.

In another embodiment, as seen in FIG. 4A, the protrusion 44 is omitted and instead a patch 45 of miniature hook material or miniature loop material is provided on the platform 42 to provide an alternative support cover receiving portion 24A. A complementary patch (not shown in the drawings) including the other one of miniature hook or loop material may then be provided on the cover element 16 to secure the cover element to the patch 45, in addition to or replacement of the apertures 40. Other manners of securing the cover element 16 to the support elements 14, 14′, either removably or permanently are also within the scope of the invention.

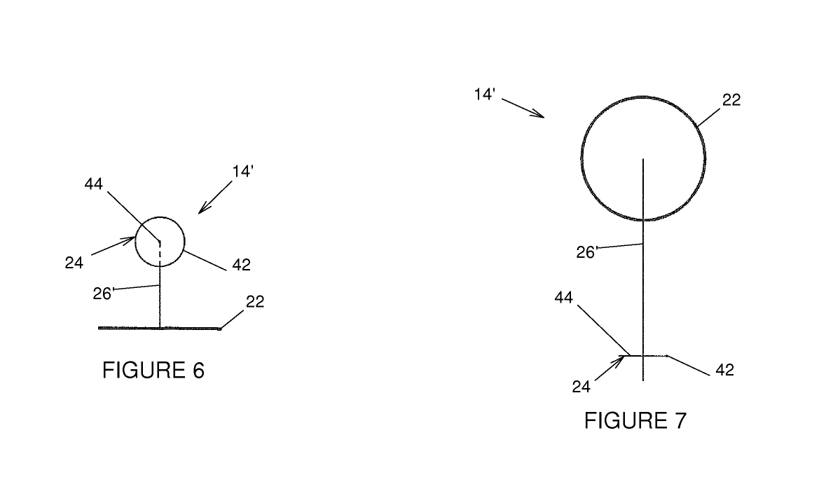

FIGS. 6 and 7 illustrate another type of support element 14′. The support element 14′ is used for example at the corners 34 of the vehicle 12 to support the cover element 16 away from the vehicle 12, and extend diagonally away from the vehicle 12, that is at an angle with the front and side edges of the vehicle 12. The support elements 14, 14′ are for example configured so that when mounted to the vehicle 12 in an operative configuration, the support elements 14, 14′ support the cover element 16 over the vehicle 12 in a substantially spaced apart relationship relative thereto. Substantially spaced apart in this context means that the cover element normally does not contact the vehicle 12, or contacts the vehicle 12 over a very minor portion thereof. For example, the wind may deflect the cover element 16 so that the bottom of the cover element 16 intermittently touches the wheels of the vehicle without departing from the meaning of “substantially spaced apart”.

The support element 14′ is similar to the support element 14 except that the support spacing portion 26′ thereof is substantially L-shaped. As such, the support spacing portion 26′ first extends away from the support vehicle mounting portion 22 generally perpendicular thereto and then bends so as to extend towards and beyond the periphery of the support vehicle mounting portion 22. Otherwise, the support element 14′ is similar to the support element 14 and the variants of the support element 14 described hereinabove also apply to the support element 14′.

In use, the support element 14 is mounted on the roof 28 and the support elements 14′ are mounted to the corners 34 of the vehicle 12, for example on the trunk and hood of a car, on the front and back fenders, or the front and back bumpers, among other possibilities. Subsequently, the aperture 40 located centrally on the cover element 16 is mounted to the protrusion 44 of the support element 14 and the apertures 40 located closer to the cover element peripheral edge 18 are each inserted on one of the protrusions 44 of a respective one of the support elements 14. In some embodiments, the cover element 16 and support elements 14, 14′ are configured such that the cover element 16 is substantially taut between the support elements 14, 14′. This may require differently sized cover elements 16 and/or support elements 14, 14′ for different vehicles 12.

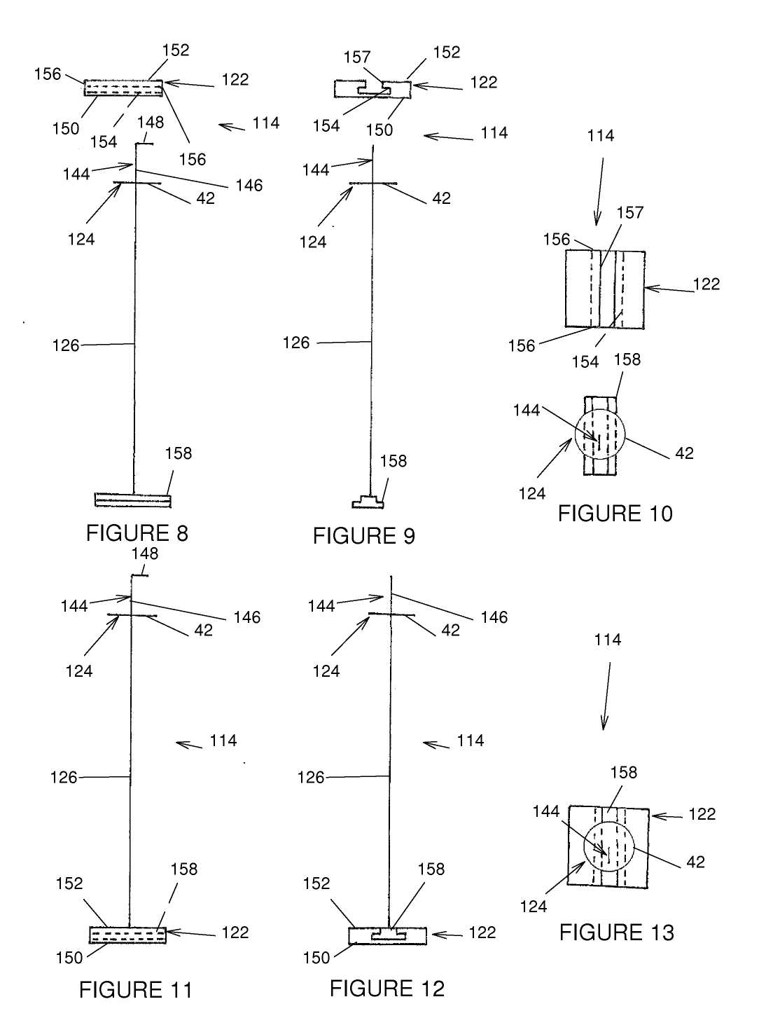

FIGS. 8 to 13 illustrate an alternative support element 114 similar to the support element 14 and usable similarly. The support element 114 differs from the support element 14 in two aspects. First, the protrusion 144 of the support cover receiving portion 124 thereof is not rectilinear, and second, the support spacing portion 126 is removably mountable to the support vehicle mounting portion 122, for example through a dovetail joint. However, other manners of removably securing the support spacing portion 126 to the support vehicle mounting portion 122 are within the scope of the invention.

As seen in FIGS. 8 and 11, the protrusion 144 defines a protrusion spacing segment 146 extending from the platform 42 and a hook 148 extending from the protrusion spacing segment 146 opposed to the platform 42, at least part of the hook 148 extending at an angle relative to the protrusion spacing segment 146. For example, the protrusion 144 is substantially L-shaped, with the protrusion spacing segment 146 being the part of the protrusion 144 that extends from the platform 42 and the hook 148 being a part of the protrusion 144 that extends generally perpendicular to the protrusion spacing segment 146, spaced apart from the platform 42. However, other types of hooks 148 are within the scope of the invention. The hook 148 reduces the likelihood that wind will remove the cover element 16 from the support element 114.

The support vehicle mounting portion 122 defines a mounting surface 150 facing the vehicle 12 when the support vehicle mounting portion 122 is operatively mounted to the vehicle 12 and an opposed free surface 152. The free surface 152 defines a channel 154 extending thereinto. For example, the channel 154 is substantially rectilinear in configuration along the free surface 152 and is substantially T-shaped with an orientation such that the channel 154 is open at at least one channel end 156 thereof, and typically at both channel ends 156 thereof, and is configured so as to define a neck 157 adjacent the free surface 152, as seen for example in FIG. 9.

The support spacing portion 126 is provided with a spacing portion mounting element 158 from which the remainder of the support spacing portion 126 extends. The spacing portion mounting element 158 is shaped complementarily to the channel 154 so as to be slidably insertable thereinto through one of the channel ends 156 and be maintained substantially snugly in the channel 154. FIGS. 8 to 10 illustrate the support spacing portion 126 unmounted from the support vehicle mounting portion 122, while FIGS. 11 to 13 show the support spacing portion 126 mounted to the support vehicle mounting portion 122.

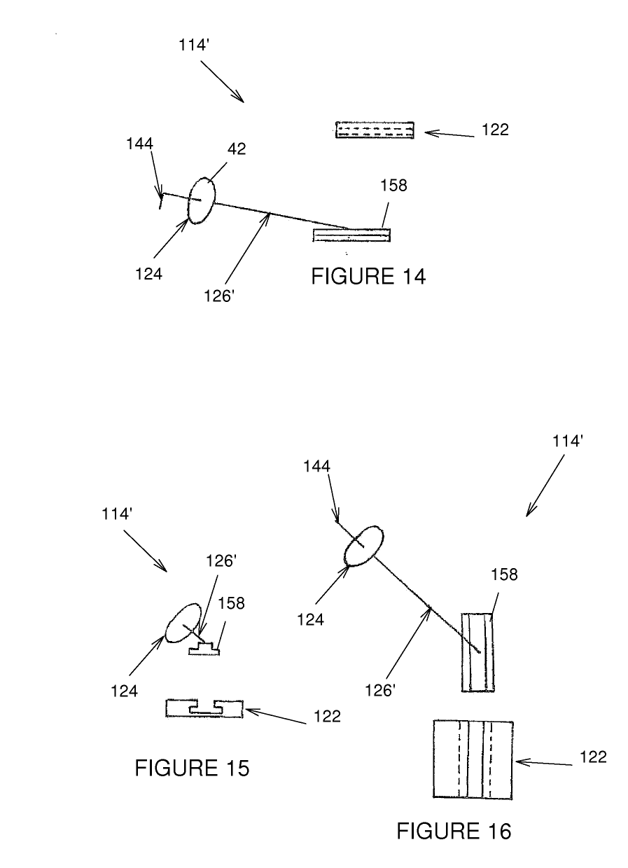

FIGS. 14 to 16 illustrate part of alternative support element 114′ similar to the support element 14′ and usable similarly. The support vehicle mounting portion 122 is usable with the combination support spacing portion 126′ and support cover receiving portion 124 of the support element 114′. The support element 114′ differs from the support element 14′ in three aspects. First, the protrusion 144 thereof is not rectilinear and is similar in shape to the protrusion 144 of the support element 114. Second, the support spacing portion 126′ thereof is removably mountable to the support vehicle mounting portion 122 thereof as in the support element 114, and third, the support spacing portion 126′ is substantially rectilinear and extends at an oblique angle from the support vehicle mounting portion 122, instead of being L-shaped.

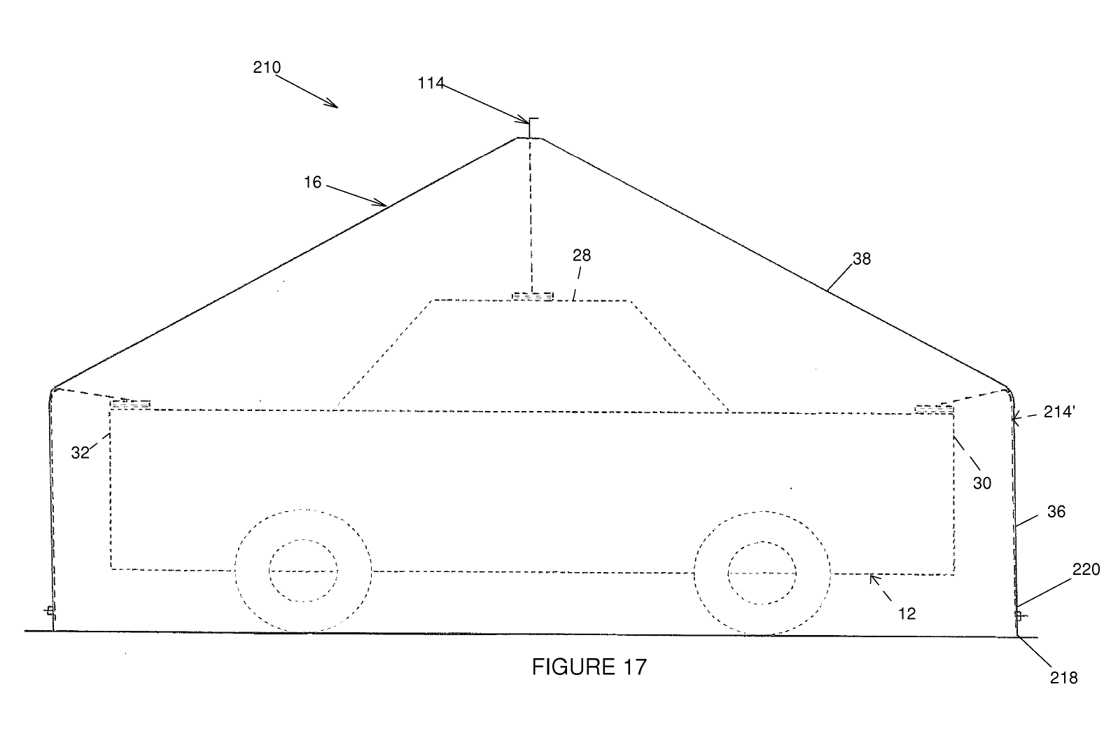

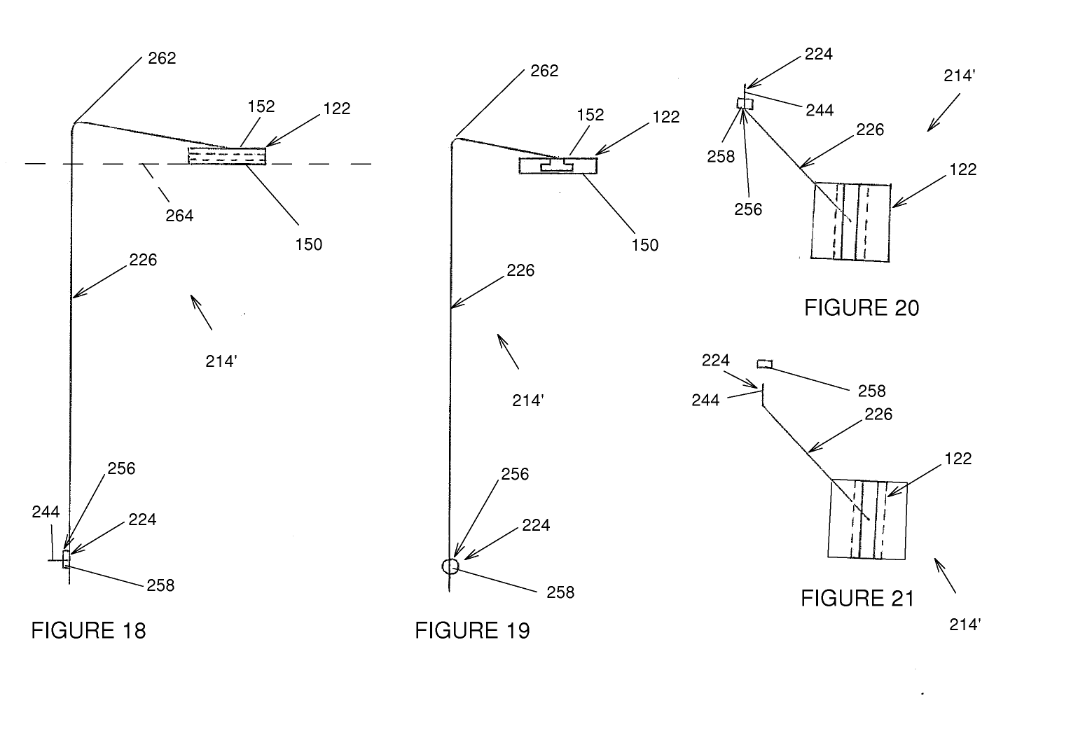

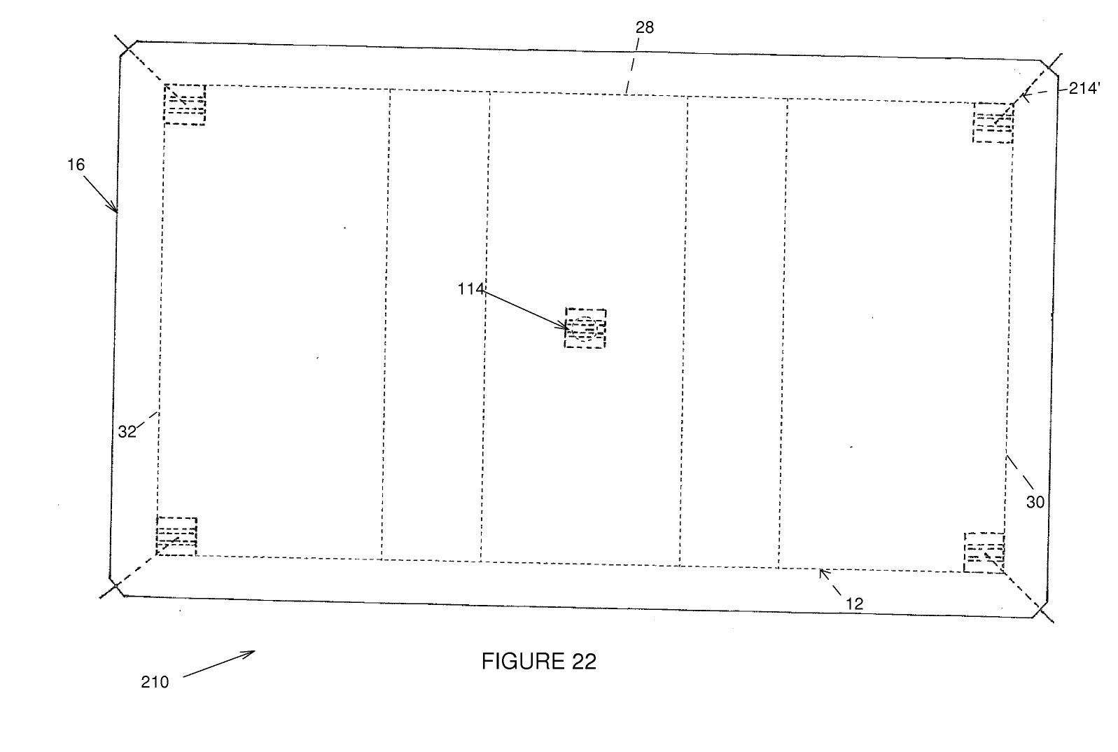

FIGS. 17 and 22 illustrate another alternative vehicle cover system 210 similar to the vehicle cover system 10. Only differences between the vehicle cover system 210 and the previously described vehicle cover system 10 are mentioned hereinbelow. In the vehicle cover system 210, the support elements 14′ and 114′ are replaced by alternative support elements 214′, better shown in FIGS. 18 to 21, while the support element 114 is used on the roof 28 of the vehicle 12. The support elements 214′ have a support vehicle mounting portion 122 similar to the support elements 114′. The support spacing portion 226 of the support element 214′ extends from the free surface 152, defines a zenith 262 and curves away from the zenith so that a mounting plane 264 containing the mounting surface 150 intersects the support spacing portion 226 at a location intermediate the zenith 262 and the support cover receiving portion 224. In other words, when referring to a support vehicle mounting portion 122 in an horizontal position on a vehicle 12, the support spacing portion 226 extends upwardly and diagonally away from the free surface 152 to then bend to extend down to a position below the support vehicle mounting portion 122, typically adjacent the ground surface on which the vehicle 12 stands.

Also, as seen in FIG. 17, the cover mounting portions 220 that are not centrally located on the cover element 16 are substantially adjacent to the cover element peripheral edge 218. Therefore, the cover element 16 is held close the periphery thereof so as to move minimally adjacent the ground.

Finally, the protrusions 244 are each provided with a lock 256 operable between a locked configuration (shown for example in FIG. 20) and an unlocked configuration (shown for example in FIG. 21). In the unlocked configuration, the aperture 40 (not shown in FIGS. 20 and 21) is freely movable along the protrusion 244. In the locked configuration, the aperture 40 is restrained on the protrusion 244 so that the cover mounting portion 220 is unable to move out of the protrusion 244. This may be achieved for example with a removable locking element 258 that is larger than the apertures 40 and slidable onto the protrusion 244 (which is typically rectilinear) and securable thereto in a conventional manner to achieve the locked configuration. Such locking elements 258 for example include a clutch (not shown in the drawings) that may be disengaged through press buttons or other mechanisms, such as the butterfly clutch mechanism found in decorative pins attachable to clothes, to allow removing the locking element 258 from the protrusion 244. When the clutch engages the protrusion 244, the locking element 258 can only be removed from the protrusion 244 using a lot of force. Removing the locking element 258 from the protrusion 244, after disengaging the clutch therefrom, achieves the unlocked configuration. It should be understood that any other suitable lock is usable in the present invention.

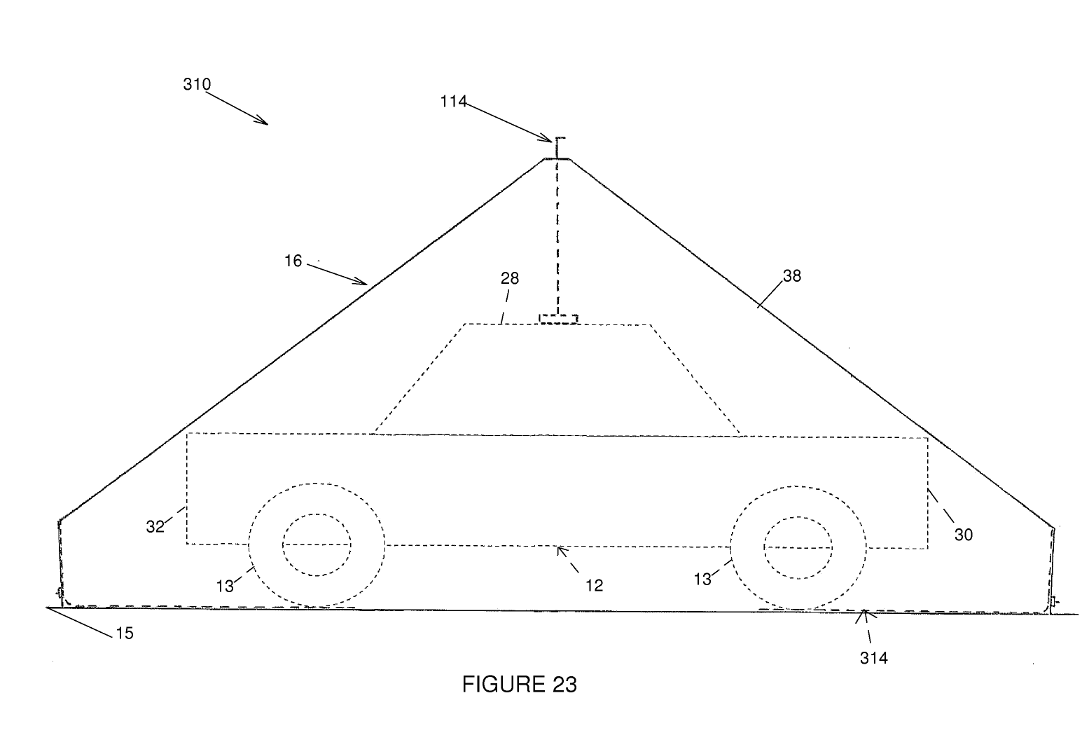

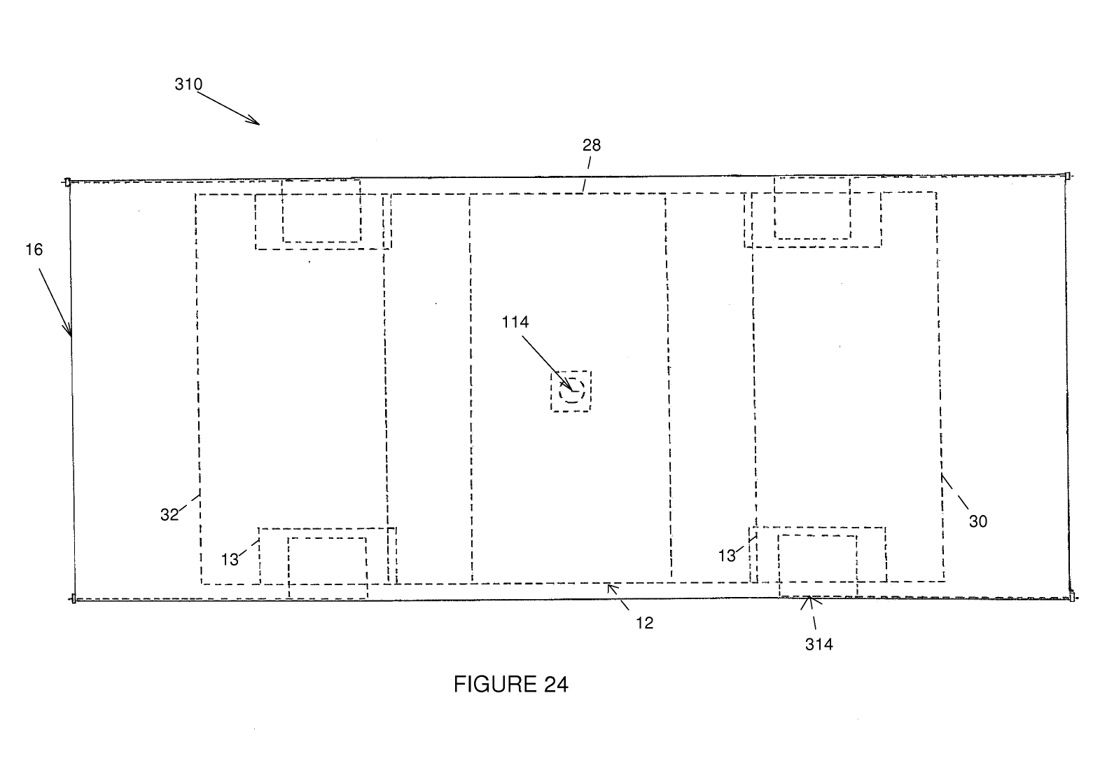

FIGS. 23 and 24 illustrate a vehicle cover system 310 in accordance with yet another embodiment of the present invention. The vehicle 12 includes at least one wheel 13, and in the case of a car typically 4 wheels 13. The vehicle 12 is provided above a ground surface 15.

The vehicle cover system 310 is similar to the above-described vehicle cover systems 10, 110 and 210 and only the differences therewith are described hereinbelow. Notably, the vehicle cover system 310 includes a vehicle mountable support element 114, mountable for example to the roof 28 of the vehicle 12. The vehicle cover system 310 further comprises at least one ground mountable support element 314, and typically a number of ground mountable support elements 314 equal to the number of wheels 13 of the vehicle 12.

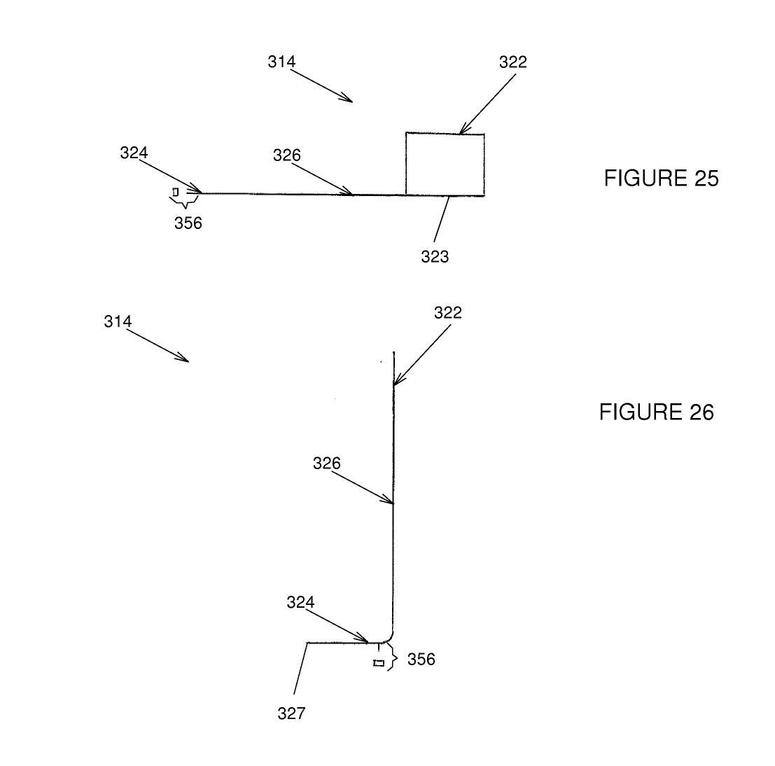

As better seen in FIGS. 25 and 26, the ground mountable support element 314 includes a ground supported portion 322 positionable on the ground 15 (not shown in FIGS. 25 and 26), a ground support cover receiving portion 324 spaced apart from the ground supported portion 322 and a ground support spacing portion 326 extending therebetween. When the ground mountable support elements 314 are mounted in an operative configuration, the ground supported portion 322 is inserted between one of the wheels 13 and the ground surface 15 and the cover element 16 is secured to the ground support cover receiving portion 324.

In the embodiment of the invention shown in the drawings, the ground supported portion 322 is substantially plate-shaped and substantially rectangular. However, other shapes for the ground supported portion 322 are within the scope of the invention. The ground support cover receiving portion 324 and ground support spacing portion 326 are formed integrally in a substantially L-shaped member extending from the ground supported portion 322 and having a distal end 327 thereof (better seen in FIG. 26), opposed to the ground supported portion 322, positioned above the ground surface 15, spaced apart therefrom. The ground support cover receiving portion 324 is similar to the support cover receiving portion 224 and includes a lock 356 similar to the lock 256. Other shapes for the ground support cover receiving portion 324 and ground support spacing portion 326 are also within the scope of the invention.

In the embodiment of the invention shown in the drawings, there are two different types of ground mountable support elements 314 that are mirror images of each other, only one type of which is shown in details in FIGS. 25 and 26. The ground support spacing portion 326 extends from the ground supported portion 322 adjacent an edge 323 thereof so that when the ground supported portion 322 is positioned between the ground surface 15 and wheel 13 and the edge 323 thereof is laterally protruding relative to the vehicle 12, the ground support spacing portion 326 extends laterally outwardly relative to the vehicle 12 so that the cover element 16 is at least partially laterally spaced apart from the vehicle 12. Two types of ground mountable support element 314 are required to achieve this configuration in the case of a four wheeled vehicle 12.

In use, one of the ground mountable support elements 314 is positioned adjacent each wheel 15 of the vehicle 13, for example with the ground supported portion 322 thereof in front of the wheel 13. It is to be understood that positioning the ground supported portions behind each wheel 15 is also a possibility. The type of ground mountable support element 314 used, in other word which mirror image component is used, is selected to that the ground support cover receiving portion 324 is provided laterally and longitudinally offset from the vehicle 12, with the distal end 327 pointing generally upwardly. Then, the vehicle 12 can be advanced to immobilize each ground supported portion 322 between the ground surface 15 and one of the wheels 13. Afterwards, or at any suitable time before, the support element 114 is mounted to the roof 28 and the cover element 16 is secured to the support element 114 and ground mountable support element 314 as described hereinabove with respect to vehicle cover system 210.

Although the present invention has been described hereinabove by way of exemplary embodiments thereof, it will be readily appreciated that many modifications are possible in the exemplary embodiments without materially departing from the novel teachings and advantages of this invention. Accordingly, the scope of the claims should not be limited by the exemplary embodiments, but should be given the broadest interpretation consistent with the description as a whole. The present invention can thus be modified without departing from the spirit and nature of the subject invention as defined in the appended claims.

What is claimed is:

1. A vehicle cover system for covering a vehicle, said vehicle cover system comprising:
at least one support element mountable to said vehicle, said at least one support element including a support vehicle mounting portion mountable to said vehicle, a support cover receiving portion spaced apart from said support vehicle mounting portion and a support spacing portion extending therebetween; and
a cover element, said cover element defining at least one cover mounting portion, said cover mounting portion being mounted to said support cover receiving portion;
wherein, when mounted to said vehicle in an operative configuration, said at least one support element supports said cover element over said vehicle in a substantially convex configuration with at least part thereof spaced apart from said vehicle.

2. A vehicle cover system as defined in claim 1, wherein
said at least one cover mounting portion includes a plurality of cover mounting portions; and
said at least one support element includes a plurality of support elements mountable to said vehicle, said support elements including each a support vehicle mounting portion mountable to said vehicle, a support cover receiving portion spaced apart from said support vehicle mounting portion for receiving a respective one of said cover mounting portions and a support spacing portion extending therebetween.

3. A vehicle cover system as defined in claim 2, wherein, when mounted to said vehicle in an operative configuration, said support elements support said cover element over said vehicle in a substantially spaced apart relationship relative thereto.

4. A vehicle cover system as defined in claim 1, wherein at least part of said at least one support element is removably mountable to said vehicle.

5. A vehicle cover system as defined in claim 4, wherein said support vehicle mounting portion is removably mountable to said vehicle.

6. A vehicle cover system as defined in claim 5, wherein said support vehicle mounting portion includes a suction element for creating a suction to secure said support vehicle mounting portion to said vehicle.

7. A vehicle cover system as defined in claim 5, wherein said support vehicle mounting portion includes a magnet for magnetically securing said support element to said vehicle.

8. A vehicle cover system as defined in claim 4, wherein said support spacing portion is removably mountable to said support vehicle mounting portion.

9. A vehicle cover system as defined in claim 8, wherein said support spacing portion is removably mountable to said support vehicle mounting portion through a dovetail joint.

10. A vehicle cover system as defined in claim 1, wherein said cover mounting portion is removably mountable to said support cover receiving portion.

11. A vehicle cover system as defined in claim 10, wherein
said cover mounting portion defines an aperture extending through said cover element;
said support cover receiving portion defines a platform for abutting said cover mounting portion thereagainst and a protrusion configured and sized for extending through said aperture and protruding therethrough when said cover mounting portion is operatively mounted to said support cover receiving portion with said cover mounting portion abutting against said platform, said platform being larger than said aperture so as to be unable to pass therethrough.

12. A vehicle cover system as defined in claim 11, wherein said protrusion defines a protrusion spacing segment extending from said platform and a hook extending from said protrusion spacing segment opposed to said platform, at least part of said hook extending at an angle relative to said protrusion spacing segment.

13. A vehicle cover system as defined in claim 12, wherein said protrusion spacing segment is substantially perpendicular to said platform.

14. A vehicle cover system as defined in claim 11, wherein said protrusion is provided with a lock operable between a locked configuration and an unlocked configuration, wherein
in said unlocked configuration, said aperture is freely movable along said protrusion; and
in said locked configuration, said aperture is restrained on said protrusion so that said cover mounting portion is unable to move out of said protrusion.

15. A vehicle cover system as defined in claim 1, wherein said cover element includes a substantially flexible cover sheet.

16. A vehicle cover system as defined in claim 15 wherein said cover sheet is a tarp.

17. A vehicle cover system as defined in claim 16, wherein said tarp is impermeable.

18. A vehicle cover system as defined in claim 15, wherein said cover sheet is substantially rectangular when flattened.

19. A vehicle cover system as defined in claim 1, wherein said at least one support element includes three support elements mounted respectively to a roof, a front portion and a rear portion of said vehicle when said vehicle cover system is operatively mounted to said vehicle.

20. A vehicle cover system as defined in claim 1, wherein said at least one support element includes five support elements mounted respectively to a roof and at a respective one of four corners of said vehicle when said vehicle cover system is operatively mounted to said vehicle.

21. A vehicle cover system as defined in claim 1, wherein said support spacing portion of said at least one support element is substantially rectilinear and extends away from said support vehicle mounting portion.

22. A vehicle cover system as defined in claim 1, wherein said support spacing portion of said at least one support element is substantially L-shaped.

23. A vehicle cover system as defined in claim 1, wherein
said support vehicle mounting portion defines a mounting surface facing said vehicle when said support vehicle mounting portion is operatively mounted to said vehicle and an opposed free surface;
said support spacing portion of said at least one support element extending from said free surface, defining a zenith and curving away from said zenith so that a mounting plane containing said mounting surface intersects said support spacing portion at a location intermediate said zenith and said support cover receiving portion.

24. A vehicle cover system as defined in claim 23, wherein said cover element defines a cover element peripheral edge, said at least one cover mounting portion being substantially adjacent to said cover element peripheral edge.

25. A vehicle cover system as defined in claim 1, wherein said cover element has a substantially rectangular circus tent shape so as to cover a substantially rectangular area when mounted in an operational configuration to said vehicle, said cover element defining a substantially parallelepiped shaped bottom portion and a substantially pyramidal shaped top portion extending therefrom.

26. A vehicle cover system as defined in claim 1, wherein said vehicle includes at least one wheel and is provided above a ground surface, said at least one support element being a vehicle mountable support element, said vehicle cover system further comprising at least one ground mountable support element, said ground mountable support element including a ground supported portion positionable on said ground, a ground support cover receiving portion spaced apart from said ground supported portion and a ground support spacing portion extending therebetween wherein, when said at least one ground mountable support element is mounted in an operative configuration, said ground supported portion is inserted between said at least one wheel and said ground and said vehicle cover is secured to said ground support cover receiving portion.

27. A vehicle cover as defined in claim 26, wherein said ground supported portion is substantially plate-shaped.
